(19) United States
(12) Patent Application Publication
(10) Pub. No.: US 2007/0118275 A1
(43) Pub. Date: May 24, 2007

(54) Traffic information gathering and query system and method thereof

(75) Inventors: Hongwei Qi, Beijing (CN); Yuguang Liu, Beijing (CN); Yabo Wang, Beijing (CN); Xiaowei Liu, Beijing (CN); Huifeng Liu, Beijing (CN)

Correspondence Address: SUGHRUE MION, PLLC, 2100 PENNSYLVANIA AVENUE, N.W., SUITE 800, WASHINGTON, DC, 20037, US

(73) Assignee: NEC (China) CO., LTD.

(21) Appl. No.: 11/598,726

(22) Filed: Nov. 14, 2006

(30) Foreign Application Priority Data
Nov. 15, 2005 (CN) 2005-10125304.1

(51) Int. Cl. G08G 1/00; G06F 19/00

(52) U.S. Cl. 701/117

(57) ABSTRACT

The invention provides a traffic information gathering device, a traffic information gathering method, a traffic information gathering and searching system and a traffic information gathering and searching method. The traffic information gathering and searching system for receiving traffic information from a user terminal and providing traffic information query service, comprises a map knowledge base generating section for generating information comprising attributes of roads and traffic points, attribute values corresponding to the attributes, and spatial relationship among the attribute values based on an electronic map so as to form a map knowledge base; a traffic information processing section for receiving traffic information from the user terminal, and decomposing the traffic information if it is determined that the traffic information can be decomposed according to the map knowledge base, so as to generate traffic information corresponding to attribute values of roads or traffic points; and a query information processing section for receiving a query request from the user terminal and analyzing it, decomposing the query request if it is determined that the query request can be composed according to the map knowledge base, and searching the traffic information database based on the decomposed query request.

### FIELD OF THE INVENTION

The invention relates to the technology of the processing of gathering traffic information from a user terminal and providing traffic information query, and more specifically, to a traffic information gathering device and method thereof, a traffic information gathering and query system, and a method thereof.

### BACKGROUND OF THE INVENTION

Despite of the continuous investment in road construction in massive amounts of financial and human resources, the fast increasing numbers of vehicles still brings about the overload of the road capability and causes traffic jam. In fact, road congestion is persistent major factor in many cities. So it is needed to give proper attention to and take into account of providing traffic information to a driver in time. Therefore, the driver can efficiently schedule the travel route to the destination. So it is very necessary to proved real-time/history traffic information to a driver.

The U.S. patent application No. 20050080552 A1, titled as “method and system for modeling and processing vehicular traffic data and information and applying thereof”, focuses on route recommendation and navigation system and a method thereof.

The EP patent application No. 1503355, titled as “A device, system and a method for processing statistic traffic information”, focuses on a system of traffic status prediction based on historical traffic information and a method thereof.

FIG. 1 shows the schematic block of a traffic information gathering and presenting method. The method of traffic information gathering includes gathering information from a fixed sensor, monitor, mobile sensor or traffic observer, etc. (S1), converting the traffic information from different traffic information source, combining the information and performing a integrating process (S2) and sending the traffic information to users via a traffic guide indicator or a radio broadcast (S3).

The existing prior art provides traffic information service just based on traffic sensor/mobile sensor information etc., in fact, if only these kind of information are available, it is not enough. For example, because of large amounts and expenditures in the necessary infrastructure and maintenance, lots of cities just set sensors on major roads, however, in fact, users not only want to get traffic information about the major roads, but also traffic information about the minor roads.

The traffic information source is limited, so the traffic information gathered by the current traffic information gathering method cannot satisfy the users' need for the traffic information because there is a great deal of demand for traffic information from users.

Usually the text traffic information is processed manually or processed automatically by a computer. But the accuracy of the processing is not satisfied. The reason is that the text traffic information generally contains concealed deep-level information. The current method cannot analyze the concealed information. For example, if the source text traffic information tells us that “West second ring, north bound, traffic slow”, we will not get the knowledge that the north bound of the “Xizhimen bridge”, the place such as “Guanyuan bridge”, “Guanyuan park”, “Fuchengmen bridge” and “Fuxingmen bridge” must be traffic slow when the text traffic information is processed only according to the literal information of the text traffic information. Those place such as “Xizhimen bridge”, “Guanyuan bridge”, “Fuchengmen bridge” and “Fuxingmen bridge” are points on the “West second ring” and “Guanyuan park” is the roadside point of “West second ring” according to an electronic map. It is deduced from “West second ring, north bound, traffic slow” that the points on the West second ring are also traffic slow in the north bound direction.

Traditional traffic information providing method includes broadcasting traffic information, overlapping traffic information on a map and display the information. But a user cannot get the traffic information that he requires timely based on broadcast and the acquired traffic information is not accurate enough. The needed traffic information cannot be acquired according to a user's demand and the user just receives the traffic information passively. Additional expensive devices are needed when the traffic information is overlapped on the map of a traffic information guide indicator, such as GPS. The service of initiative query of traffic information cannot be provided to a user.

### SUMMARY OF THE INVENTION

The invention is made to address the above problems. The object of the present invention is to provide a traffic information gathering device, which receives the traffic information sent from a user, and collects the information and processes it. The other object of the present invention is to provide a C2C (Custom to Custom) traffic information gathering and searching system which queries traffic information, wherein C2C refers to user to user, i.e., a self-helping service among users. A user sends traffic information conveniently and timely so that the source of the traffic information is broad. On the other hand, a user terminal queries traffic information conveniently and accurately as well as timely without additional terminal devices. Therefore, the cost is reduced.

According to the first aspect of the invention, a traffic information gathering device is provided, comprising:

a map knowledge base generating section for generating information comprising attributes of roads and traffic points, attribute values corresponding to the attributes, and spatial relationship among the attribute values based on an electronic map so as to form a map knowledge base; and

a traffic information processing section for receiving traffic information from a user terminal, and decomposing the traffic information if it is determined that the traffic information can be decomposed according to the map knowledge base, so as to generate traffic information corresponding to attribute values of roads or traffic points.

According to the second aspect of the invention, a traffic information gathering method is provided, comprising:

map knowledge base generating step for generating information comprising attributes of roads and traffic points, attribute values corresponding to the attributes, and spatial relationship among the attribute values based on an electronic map so as to form a map knowledge base; and

traffic information processing step for receiving traffic information from a user terminal, and decomposing the traffic information if it is determined that the traffic information can be decomposed by using the map knowledge base, so as to generate traffic information corresponding to attribute values of roads or traffic points.

According to the third aspect of the invention, a traffic information gathering device is provided, comprising:

a traffic information receiving section for receiving the traffic information from the user terminal as first traffic information;

a traffic information analyzing section for identifying the format of the first traffic information, decomposing the first traffic information into second traffic information which is corresponding to the attribute values of roads of traffic points if it is determined that the first traffic information can be decomposed according to the map knowledge base, wherein the map knowledge base comprises knowledge related to attributes of roads and traffic points, attribute values corresponding to the attributes, and spatial relationship among the attribute values based on an electronic map; and

a traffic information integrating section for integrating the first and second traffic information with the traffic information of a traffic information database and updating the traffic information database using the integrated traffic information.

According to the fourth aspect of the invention, a traffic information gathering method is provided, comprising:

a receiving step for receiving the traffic information from the user terminal as first traffic information;

an traffic information analyzing step for identifying the format of the first traffic information, decomposing the first traffic information into second traffic information which is corresponding to the attribute values of roads of traffic points when the first traffic information can be decomposed according the map knowledge base, wherein the map knowledge base comprises information related to attributes of roads and traffic points, attribute values corresponding to the attributes, and spatial relationship among the attribute values based on and electronic map; and

a traffic information integrating step for integrating the first and second traffic information with the traffic information of a traffic information database and updating the traffic information database using the integrated traffic information.

According to the fifth aspect of the invention, there is provided a traffic information gathering and searching system for receiving traffic information from a user terminal and providing traffic information query service, comprising:

a map knowledge base generating section for generating information comprising attributes of roads and traffic points, attribute values corresponding to the attributes, and spatial relationship among the attribute values based on an electronic map so as to form a map knowledge base;

a traffic information processing section for receiving traffic information from the user terminal, and decomposing the traffic information if it is determined that the traffic information can be decomposed according to the map knowledge base, so as to generate traffic information corresponding to attribute values of roads or traffic points; and

a query information processing section for receiving a query request from the user terminal and analyzing it, decomposing the query request if it is determined that the query request can be composed according to the map knowledge base, and searching the traffic information database based on the decomposed query request.

According to the sixth aspect of the invention, there is provided a traffic information gathering and searching method for receiving traffic information from a user terminal and providing traffic information query request service, comprising:

a map knowledge base generating step for generating information comprising attributes of roads and traffic points, attribute values corresponding to the attributes, and spatial relationship of the attribute values based on an electronic map so as to form a map knowledge base;

a traffic information processing step for receiving traffic information from the user terminal and analyzing it, and decomposing the traffic information if it is determined that the traffic information can be decomposed according to the map knowledge base, so as to generate traffic information corresponding to attribute values of roads or traffic points; and

user terminal, decomposing the query request if it is determined that the query request can be composed according to the map knowledge base, and searching the traffic information database based on the decomposed query request.

According to the seventh aspect of the invention, there is provided a traffic information gathering and searching system for receiving traffic information from a user terminal and providing traffic information query service, comprising:

a traffic information processing section for receiving traffic information from the user terminal, and decomposing the traffic information if it is determined that the traffic information can be decomposed according to the map knowledge base, so as to generate traffic information corresponding to attribute values of roads or traffic points, wherein the map knowledge base comprises knowledge related to attributes of roads and traffic points, attribute values corresponding to the attributes, and spatial relationship of the attribute values based on an electronic map; and

a query information processing section for receiving a query request from the user terminal, decomposing the query request if it is determined that the query request can be composed according to the map knowledge base, and searching the traffic information database based on the decomposed query request.

According to the eighth aspect of the invention, there is provided a traffic information gathering and searching method for receiving traffic information from a user terminal and analyzing it, providing traffic information query request service, comprising:

a traffic information processing step for receiving traffic information from the user terminal and analyzing it, and decomposing the traffic information if it is determined that the traffic information can be decomposed according to the map knowledge base, so as to generate traffic information corresponding to attribute values of roads or traffic points, wherein the map knowledge base comprises knowledge related to attributes of roads and traffic points, attribute values corresponding to the attributes, and spatial relationship of the attribute values based on an electronic map; and

a query information processing step for receiving a query request from the user terminal and analyzing it, decomposing the query request if it is determined that the query request can be composed according to the map knowledge base, and searching the traffic information database based on the decomposed query request.

### BRIEF DESCRIPTION OF THE DRAWINGS

FIG. 1 shows a method of gathering and presenting traffic information according to the invention.

FIG. 2 shows a traffic information gathering device according to the invention.

FIG. 3 shows a process flow chart of a map knowledge base generated by a map knowledge base generating device.

FIG. 4 shows a part of a map knowledge base.

FIG. 5 shows a schematic diagram corresponding to the map knowledge map according to the invention.

FIG. 6 shows a flow chart of analyzing the traffic information sent by a user terminal.

FIG. 7 shows a flow chart of integrating the traffic information according to the invention.

FIG. 8a shows an example of a traffic information database according to the invention.

FIG. 8b shows an example of a traffic status description table.

FIG. 9 shows an example of analyzing and integrating traffic information.

FIG. 10 shows a schematic block of traffic information gathering and searching system according to a first embodiment of the invention.

FIG. 11 shows a flow chart of performing user query analysis according to the invention.

FIG. 12 is a flow chart of performing traffic information query and combining the query result.

FIG. 13a shows an analyzed result of the received example traffic information.

FIG. 13b shows an analyzed result of the example user query.

FIG. 13c shows a part of the map related to the analysis of the user traffic information.

FIG. 13d shows a schematic diagram of analyzing a user traffic information query and combining the query result.

FIG. 14 shows another block of the traffic information gathering and searching system according to another embodiment of the invention.

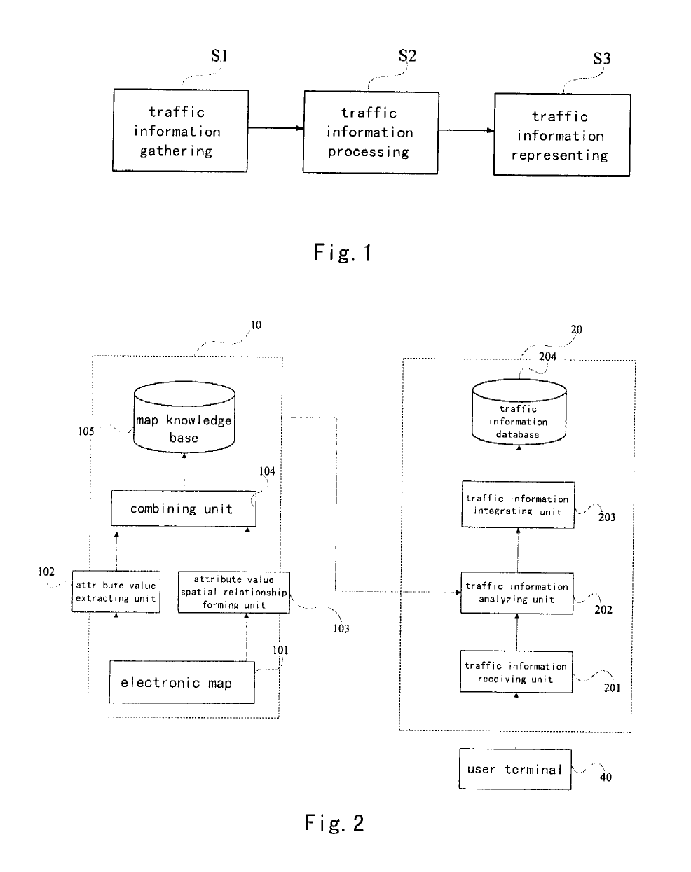

### DETAILED DESCRIPTION OF THE PREFERRED EMBODIMENTS

Hereinafter, the preferred embodiments will be illustrated with reference to the drawings. In the drawings, same elements are illustrated by the same symbols or numbers. Moreover, in the following description of the present invention, a detailed description of known functions and configurations incorporated herein will be omitted in order not to make the subject matter of the present invention unclear.

FIG. 2 shows a traffic information gathering device according to the invention. The traffic information gathering apparatus comprises a map knowledge base generating device 10, traffic information processing device 20 and a storing device for storing a traffic status description table which describes the status of the traffic (not shown). The map knowledge base generating device 10 comprises an electronic map 101, an attribute value extracting unit 102, an attribute value spatial relationship forming unit 103, a combing unit 104 and a map knowledge base 105. The a traffic information processing device 20 comprises a traffic information receiving unit 201, a traffic information analyzing unit 202, a traffic information integrating unit 203 and a traffic information database 204. A user terminal 40 connects to a traffic information gathering device via a communication network (not shown). The user terminal 40 includes, but not limit to, wired and wireless communication device, for example, a mobile phone, a PDA (personal digital assistant) and computer. The traffic information processing device 20 analyzes the traffic information according to the map knowledge base 105 generated by the map knowledge base generating device 10 and integrates the traffic information to update the traffic information database 204 when the traffic information is received via a communication network. Therefore, traffic information sent from the user terminal is gathered automatically and is processed by using the traffic information gathering device. Thus the needed traffic information is gathered.

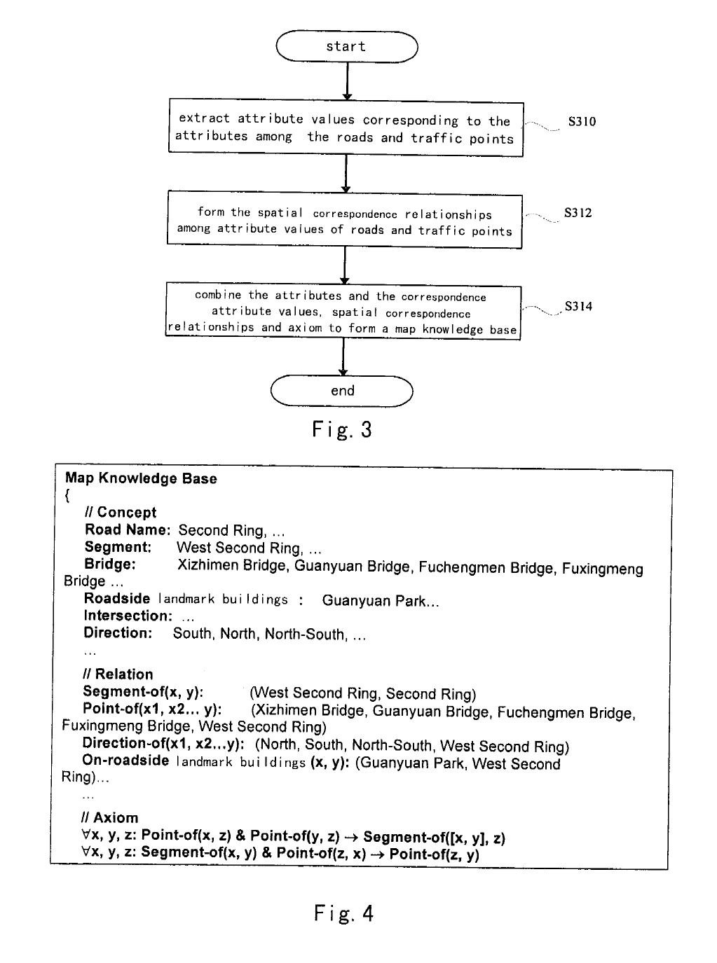

FIG. 3 shows a process flow chart of a map knowledge base generated by a map knowledge base generating device. For the purpose of describing clearly, the structure of the map knowledge base 105 will be described in conjunction with FIG. 4. As FIG. 4 shown, the map knowledge base 105 generally comprises three parts: Concept part, Relation part and Axiom part.

(1) Concept part is composed of various attributes among roads and traffic points describing the electronic map, which is represented as (Attribute: Attribute Value 1, Attribute Value 2, . . . ). The types of attributes include two different kinds. One is a type of roads and traffic points, and specifically, it includes road names, road segments, bridges, intersection and roadside landmark buildings, etc., for example (road name: the second ring, . . . ). The second is the characteristics of the roads and traffic points, and specifically, it includes directions, etc., for example (direction: North bound, South bound, North-South bound . . . ) as FIG. 4 shows.

(2) Relation part is used to define the space relationship of attribute values corresponding to attributes among roads and traffic points in the concept part, such as “segment-of(x, y)” helps describe that a road segment x is a part of a road y. For example, West second ring is a part of the second ring “point-of(x1, x2, . . . , y)” is used to describe some traffic points x1, x2, . . . , are points on a road y, such as the Xizhimen bridge, the Guanyuan bridge, the Fuchengmen bridge, the Fuxingmen bridge are points on West second ring. Furthermore, “direction-of (x1, x2, . . . , y)” is used to describe a road or traffic point y includes direction x1, x2, . . . etc., such as “the Xizhimen bridge” has three directions: north bound, south bound and north-south bound. The function of the relation part is to deduce space relationship of attribute values among the roads and traffic points, for example, it deduces that the Xizhimen bridge, the Guanyuan bridge, the Fuchengmen bridge, the Fuxingmen bridge are points on West second ring, according to point-of(the Xizhimen bridge, the Guanyuan bridge, the Fuchengmen bridge, the Fuxingmen bridge, West second ring).

(3) Axiom part includes theorems on which further deductions can be performed, such as ∀x, y, z: Segment-of(x, y) & point-of(z, x)→point-of (z, y). If west second ring is one segment of the second ring, and the Xizhimen bridge is a point of the west second ring, then it can be deduced that the Xizhimen bridge is also a point of the second ring. The amounts of theorems in the axiom part are limited and they can be extended as required. FIG. 4 only shows two examples. Usually, axiom part is organized and determined manually.

The map knowledge base generating device 10 is used to input information such as spatial relationship among attribute values of roads and traffic points from the electronic map 101 to the map knowledge base 105. The map knowledge base generating device 10 in mainly based the functions provided by the GIS (Geographical Information System) platform. These functions are commonly used by those skilled in the art. The representative GIS platform includes MapInfo, ArcInfo, and SuperMap.

The procedure of generating the map knowledge base 105 by the map knowledge base generating device 10 shown in FIG. 4 will be illustrated in detail with reference to FIG. 3.

Referring to FIG. 3, at S310, the attribute value extracting unit 102 extracts attribute values corresponding to the attributes among each of the roads and traffic points from the electronic map 101 by using GIS function. Therefore, the concept part is constructed by attributes and their corresponding attribute values among roads and traffic points. Namely, the attribute values corresponding to attributes comprise such as road names, road segment, bridge, intersection and roadside landmark buildings, are extracted. It obtains such as the attributes (bridge: the Xizhimen bridge, the Guanyuan bridge, the Fuchengmen bridge, the Fuxingmen bridge . . . ) with respect to attribute “bridge”. The traffic points are points related to traffic information on a road, more specifically, they may comprise bridge, segments, intersection, and roadside landmark buildings, etc. That is to say, the traffic points include nodes on a road (such as bridge, segments, intersection, etc.) and roadside points near to the road (such as roadside landmark buildings, etc.)

At S312, the attribute value spatial relationship forming unit 103 fills in the spatial correspondence relation among attribute values of roads and traffic points by using GIS function, thereby the relation part of the map knowledge base is formed, for example, for relation “soDatasetVector.QueryEx(objGeometry As soGeometry, scsCommonPoint,”) as soRecordset”. It is used to query how many points (bridges) are on a road. It can be obtained from the above function “point-of (the Xizhimen bridge, the Guanyuan bridge, the Fuchengmen bridge, the Fuxingmen, West second ring)”. It means “the Xizhimen bridge”, “the Guanyuan bridge”, “the Fuchengmen bridge” and “the Fuxingmen bridge” are the points (bridges) on West second ring.

At S314, the combining unit 104 combines the attribute values corresponding to attributes among roads and traffic points and the attributes, filled spatial relationship among attribute values of roads and traffic points and axiom part based relation part, so as to form the map knowledge base 105 as shown in FIG. 4. The map knowledge base 105 is used for providing spatial information among attribute values of roads and traffic points that is processed in deep-level.

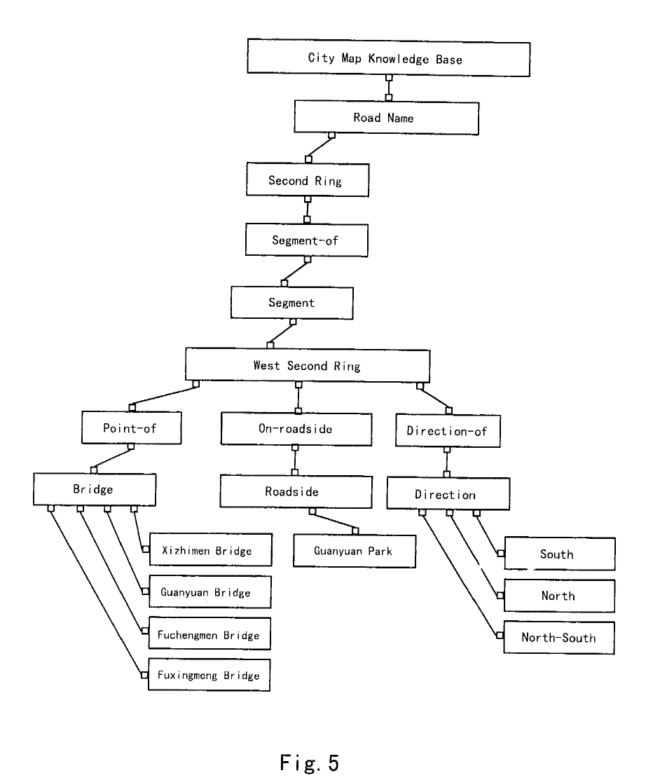

FIG. 5 shows a map structure corresponding to the map knowledge base. The map knowledge base is converted to the map structure shown as in FIG. 5 and is stored into the memory of a computer. The conversion method comprise:
(1) Take attribute names and attribute values in the concept part and relation names in the relation part as nodes (such as shown in the rectangle block).
(2) Takes the associations among the attributes and attribute values in the concept part and the dependence relation of attribute values of roads and traffic points in relation part as sides (such as the side which connects the two rectangle blocks)

There are a lot of methods used to obtain the deduction based on the map structure shown in FIG. 5. Reference can be made to Proposed design for gR, a graphical models toolkit for R, Kevin P. Murphy, 2003, which can be obtained from the following websites: http://www.cs.ubc.ca/˜murphyk/Software/BNT/gr03.pdf. Moreover, if necessary, deduction can be performed by using the theorems in axiom part shown in FIG. 4. Those theorems are established on the basis of FIG. 5. The deduction function is known by those skilled in the art.

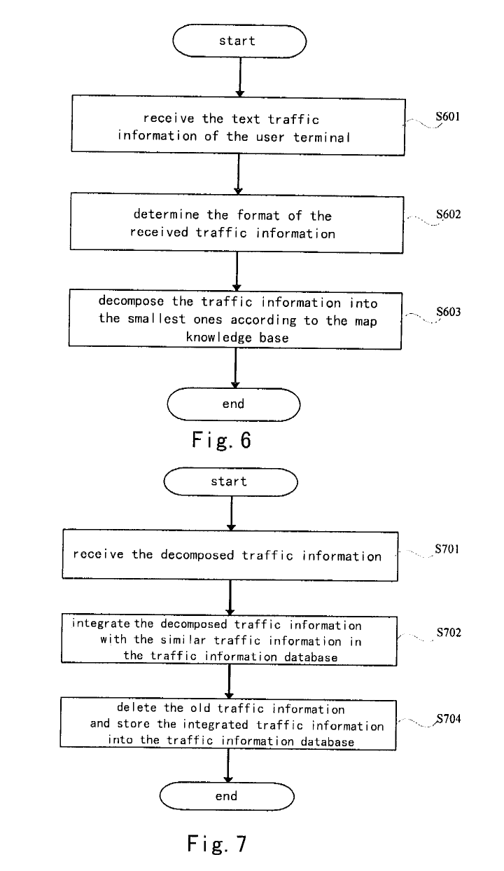

FIG. 6 shows a flow chart of analyzing the traffic information sent from a user terminal. The receiving unit 201 receives text traffic information from the user terminal 40, such as a mobile telephone.

Generally, text traffic information sent from a user terminal includes the formats:

“Where, traffic status” (for example, “Guanyuan bridge, traffic jam”):

“Where, Direction, traffic status” (for example, “Xizhimen bridge, North bound, traffic slow”);

“Where, traffic status, time” (for example, “Xizhimen bridge, traffic slow, 9:12”),

“Where, Direction, traffic status, time” (for example, “West second ring, North bound, traffic slow, 10 o'clock”), and

“from where to where, direction, traffic status” (for example, “from the Xizhimen bridge to the Fuxingmen bridge, north bound, traffic jam”). The traffic information sent from the user terminal may include “time”.

Although taking those text traffic information of the above formats as examples to describe the processing of the traffic information, the invention is not limited to the above text traffic information with the above formats.

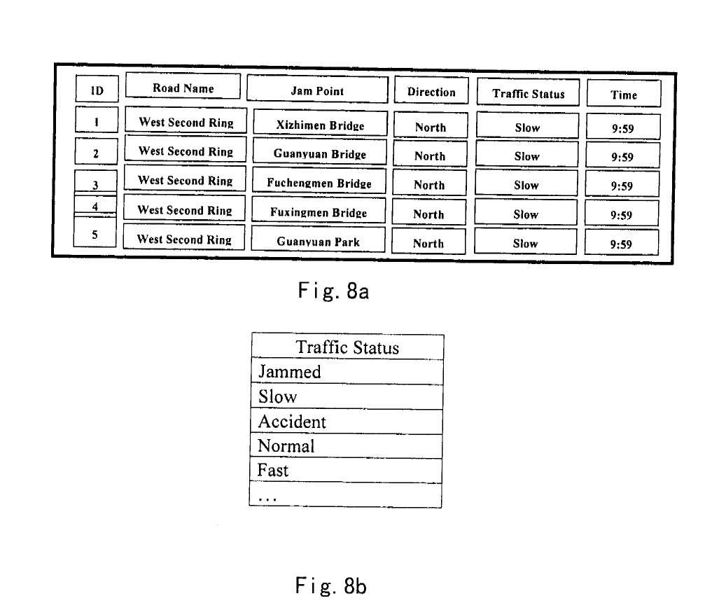

The traffic information analyzing unit 202 analyzes the traffic information (for example, “West second ring, north bound, traffic slow”) after it is received. First, the format of the received traffic information is determined to judge whether it needs to be decomposed at S602 or not. For a traffic information “West second ring, North bound, traffic slow” sent from a user terminal, the analyzing unit 202 determines that it belongs to the format “Where, Direction, traffic status”, wherein “Where=West second ring”, “Direction=north bound” and “traffic status=traffic slow”. Then the analyzing unit 202 identifies “Where” in the traffic information by matching it with the attribute values such as “road name”, “segment”, “bridge”, “intersection”, “roadside landmark buildings” in the concept part in the map knowledge base 105. The analyzing unit 202 identifies the “direction” in the traffic information by matching it with the “direction” in the concept part in the map knowledge base 105, and identifies the “traffic status” from the traffic information by matching it with the traffic status description table shown in FIG. 8b. FIG. 8b shows an example of traffic status description table with the status of traffic jam, slow, accidents, normal and fast, etc. Since “Where=West second ring”, the analyzing unit 202 determines that it should be decomposed according to the relation part in the map knowledge base 105. If the traffic information sent form a user terminal is “Guanyuan bridge traffic jam” the analyzing unit 202 determines that “Guanyuan bridge” needs not to be decomposed according to the relation part in the map knowledge base 105.

Furthermore, when the determined query request is the “from where to where, direction, Question” format, the analyzing unit 202 will identify “from where” and “to where”, then converts them to “Where”. After that, the above matching is performed.

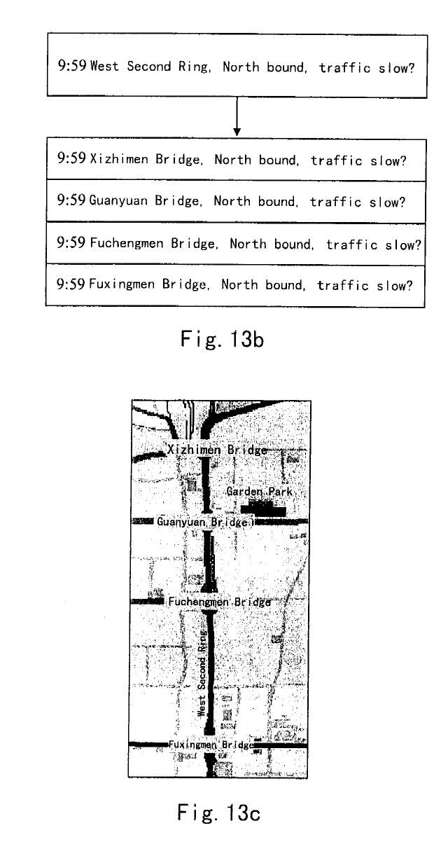

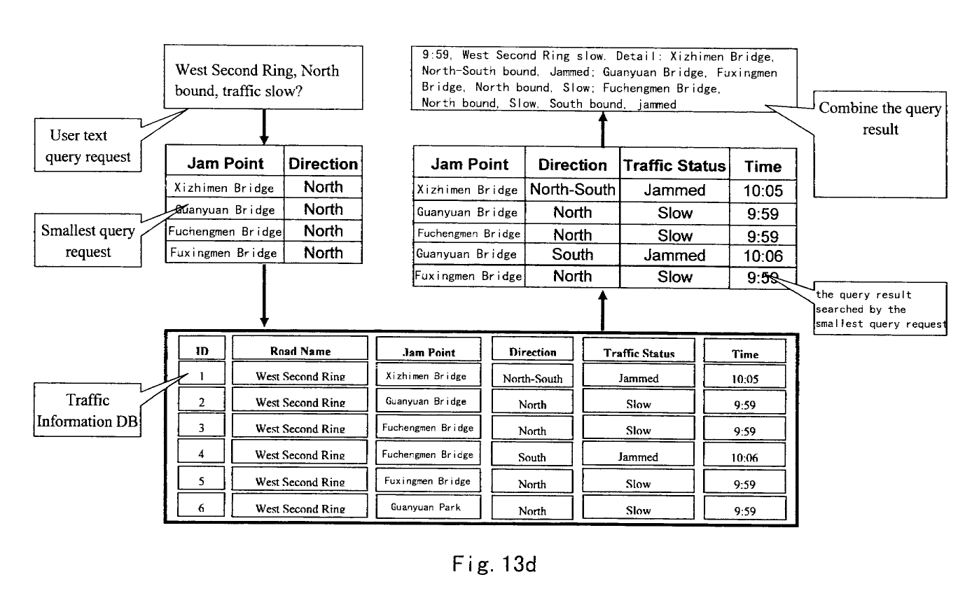

Then, the traffic information analyzing unit 202 decomposes the traffic information that needs to be decomposed into the minimum traffic information according to the map knowledge stored in the map knowledge base 105 at S603. The minimum traffic information means the received traffic information is decomposed into roads and traffic points which cannot be decomposed further. Referring to FIGS. 13a and 13c, FIG. 13c shows the segment of “West second ring”, and for the “West second ring” in the received traffic information “West second ring, north bound, traffic slow”, it can be deduced that “Xizhimen bridge”, “Guanyuan bridge”, “Fuchengmen bridge” and “Fuxingmen bridge” are points on “West second ring” according to “point-of(the Xizhimen bridge, the Guanyuan bridge, the Fuchengmen bridge, the Fuxingmen bridge, West second ring)” in the relevant part of the map knowledge base 105. It is deduced from the “roadside representing construction (Guanyuan park, West second ring)” that “Guanyuan park” is a point near the “West second ring”. All the traffic information about the West second ring is decomposed to “the Xizhimen bridge”, “the Guanyuan bridge”, “the Fuchengmen bridge”, “the Fuxingmen bridge”, and “Guanyuan park” and it cannot be composed further. Then, the traffic information analyzing unit 202 sends the analyzed traffic information to the traffic information integrating unit 203.

FIG. 7 shows a flow chart of integrating the traffic information according to the invention. One significant feature of traffic information is redundancy. In hundreds pieces of traffic information, maybe half of them is about the same road and traffic point. Therefore, it is very important to integrate the redundancy information of the traffic information.

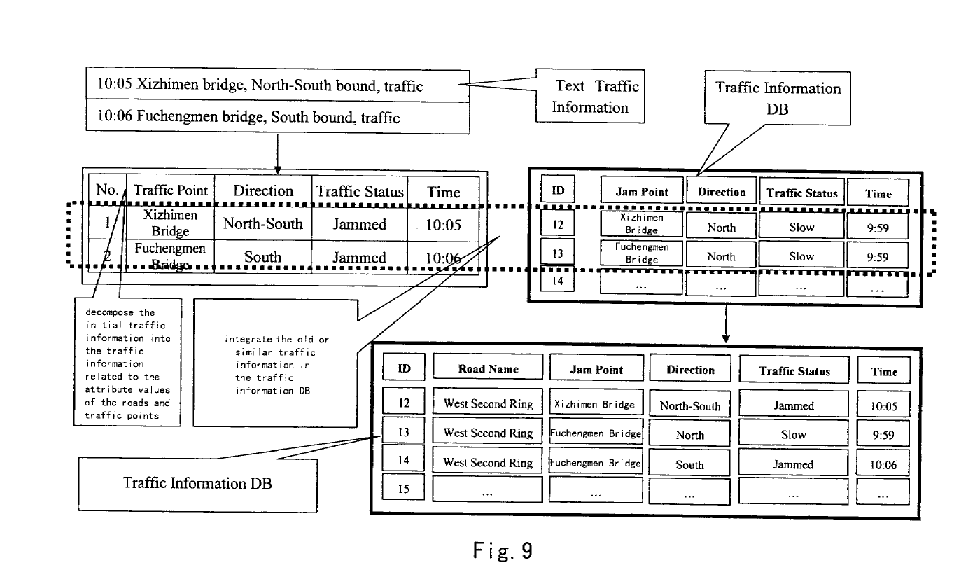

Referring to FIG. 7, the traffic information integrating unit 203 receives the minimum traffic information decomposed by the traffic information analyzing unit 202 at S701. The traffic information integrating unit 203 integrates the decomposed traffic information and the similar traffic information in the traffic information database 204 according to the data items such as the traffic point, the direction, the traffic status and the time at S702. Then the old traffic information is deleted from the traffic information database 204 and the integrated traffic information is stored into the traffic information database 204 so as to update the traffic information database 204 at S703. FIG. 9 gives an example of analyzing and integrating the traffic information.

FIG. 8a shows an example of the traffic information database according to the invention. The data items in the shown traffic information database include road name, traffic point, direction, traffic status and time, etc.

The traffic information of attribute values of the roads and traffic point is stored in the traffic information database. Those traffic points include nodes (for example, a bridge, a segment, a intersection, etc) and road side point near the road (for example, the roadside representing construction, etc.). Therefore, the most specific traffic information is stored in the traffic information database.

Although FIG. 2 has shown that the traffic information gathering apparatus of the present invention comprises the map knowledge base generating device 10, the traffic information processing device 20 and a storing device for storing the traffic status description table (not shown), it is apparently that the traffic information gathering device can only comprises the traffic information processing device 20 and the storing device for storing the traffic status description table and uses a known map knowledge base outside the traffic information processing device 20 or inside the traffic information processing device. The map knowledge base is, for example, formed manually, only if the map knowledge base stores the knowledge related to the attributes of the roads and traffic points generated from the electronic map, attribute values corresponding to the attribute and the spatial relationship among the attribute values.

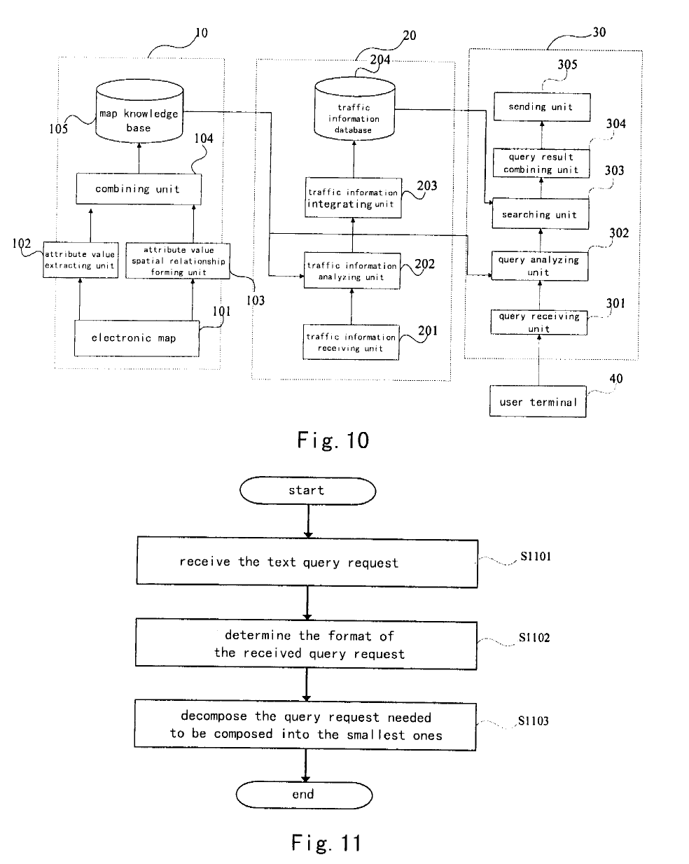

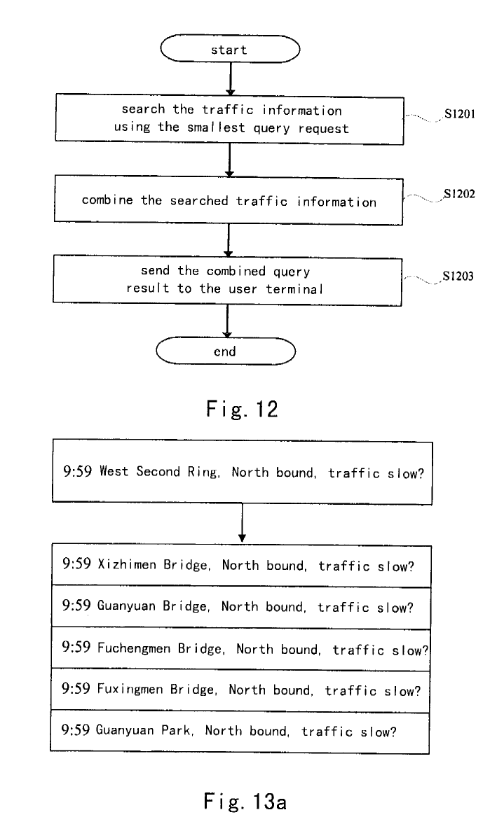

FIG. 10 shows a schematic block of traffic information gathering and searching system according to the first embodiment of the invention. The traffic information gathering and searching system comprises a map knowledge base generating device 10, a traffic information processing device 20 for processing the traffic information received from a user, a query information processing device 20 for processing the traffic information received from a user, a storing unit for storing a traffic status description table and a communication network (not shown). The map knowledge base generating device 10 and the traffic information processing device 20 is exactly the same with the map knowledge base generating device 10 and the traffic information processing device 20 shown in FIG. 2. So here the description about them is omitted. The query information processing device 30 includes a query request receiving unit 301, a query request analyzing unit 302, a searching unit 303, a query result combing unit 304 and a sending unit 305. The query request analyzing unit 302 of the query information processing device 30 analyzes the received query request by using the map knowledge base 105 generated by the map knowledge base generating device 10 and searches the traffic information by using the traffic information database 204. The processing flow chart of the query information processing device 30 according to the invention will be illustrated by referring to FIGS. 11 and 12.

The query request analyzing unit 301 of the query information processing device 30 receives text query request sent by the receiving user terminal 40 at S1101. Generally, the text query request includes the formats:

“Where” (for example, “Xizhimen bridge?”);

“Where, Direction” (for example, “Xizhimen bridge, North bound?”);

“Where, Question” (for example, “the Guanyuan bridge, traffic jam?”),

“Where, Direction, Question” (for example, “West second ring, North bound, traffic slow?”),

“Where, Time” (for example, “the Xizhimen bridge, 8:30?”);

“Where, Direction, Time” (for example, “the Xizhimen bridge, North bound, 8:30?”);

“Where, Question, Time” (for example, “the Guanyuan bridge, traffic jam, 8:30?”),

“Where, Direction, Question, Time” (for example, “West second ring, North bound, traffic slow, 8:30?”); and

“from where to where, direction, Question” (for example, “from the Xizhimen bridge to the new Fuchengmen bridge, north bound, traffic jam?”).

Although those text query request formats are used as examples to illustrate the processing of query request, the invention is not limited to the above text query request with the above-mentioned format.

The query analyzing unit 302 analyzes the query request (for example, “West second ring, North bound, traffic slow?” as shown in FIG. 13b) after receiving it.

First, the query analyzing unit 302 determines the format of the received query request and judges whether the query request needs to be decomposed or not at S1102. For a user query request “West second ring, North bound, traffic slow?”, the query analyzing unit 302 determines that it belongs to the format “Where, Direction, Question”, wherein “Where=West second ring”, “Direction=north bound” and “Question=traffic slow”. Then the query analyzing unit 302 identifies “Where” in the query request by matching it with the attribute values such as “road name”, “segment”, “bridge”, “intersection”, “roadside landmark buildings” in the concept part in the map knowledge base 105. The query analyzing unit 302 identifies the “direction” in the query request by matching it with the “direction” in the concept part in the map knowledge base 105, and identifies the “Question”of the query request by matching it with the traffic status description table shown in FIG. 8b. Since “Where=West second ring”, the query analyzing unit 302 determines that it should be decomposed according to the relation part in the map knowledge base 105. If the use's query request is “Guanyuan bridge, traffic jam?” the analyzing unit 202 determines that “Guanyuan bridge” needs not to be decomposed.

Moreover, if the query analyzing unit 302 determines that the query request is of the format of “from where to where, direction, question”, it identifies “from where” and “to where”. Then the query analyzing unit 302 translates the identified query request to “where” and performs matching process as the above paragraph.

Furthermore, when the determined query request is the “from where to where, direction, Question” format, the query analyzing unit 302 will identify “from where” and “to where”, then converts them to “Where”. After that, the above matching process is performed.

Then, the query analyzing unit 302 decomposes the query request that needs to be divided into the minimum query request according to the knowledge stored in the map knowledge base 105 at S1103. The minimum query request means the received query request is decomposed into attribute values of roads and traffic points which cannot be decomposed further. Referring to FIGS. 13b and 13c, for the “west second ring” in a query request, it can be deduced that “Xizhimen bridge”, “Guanyuan bridge”, “Fuchengmen bridge” and “Fuxingmen bridge” are points of “West second ring” according to relation “point-of(the Xizhimen bridge, the Guanyuan bridge, the Fuchengmen bridge, the Fuxingmen bridge, West second ring)” in relation part of the map knowledge base 105.

All the query requests related to West second ring is decomposed into “Xizhimen bridge”, “Guanyuan bridge”, “Fuchengmen bridge” and “Fuxingmen bridge” and they cannot be decomposed further.

Referring to FIG. 12, the searching unit 303 uses the minimum query request decomposed by the query request analyzing unit 302 to search the traffic information from the traffic information database 204.

At S1202, the query request result combining unit 304 combines the similar initial traffic information by using the data items such as traffic points, the direction, the traffic status and time, on the basis of the searched initial query request result from the traffic information database 204, so that the combined query request is formed. Therefore, there is no need to present to the user a lot of repeated or similar traffic information. The user can conveniently and directly view all the required traffic information without scrolling over the screen when a user terminal having a small screen, because the query request results are combined. Specifically, the query request result combined a great deal of traffic information includes two part: a summary part and a detailed description part. The summary is used to show the traffic status briefly and the detailed description is used to show the traffic status about the corresponding traffic point. Generally, a summary is obtained by the statistics of concentrated traffic status in the query request results. For example, when most of the query request results “traffic status” are concentrated to represent “slow”, then the traffic status is determined to be slow.

At S1203, the sending unit 305 sends the combined query request result to the user terminal 40 via a communication network. The sending unit 305 may send the combined query request result in at least one of text format, image format and voice format.

If the query quest analyzing unit 302 determines that the query request needs to be decomposed, the searching unit 303 searches the traffic information database according to the query request and the query request result is sent to the user terminal 40.

FIG. 13d shows an example of searching traffic information query request. From the FIG. 13d, the traffic information query request system analyzes the query request input by the user terminal, and combines the searched initial query request result. Therefore, the user only simply inputs the query request “west second ring, North bound, traffic slow?” to get the specific and accurate traffic information “9: 59, west second ring traffic slow. Specifically, Xizhimen bridge, North bound, traffic jam; Guanyuan bridge, Fuxingmen bridge, North bound, traffic slow, Fuchengmen bridge, North bound, traffic slow, South bound, traffic slow”.

Although the invention describes that the query information processing device 30 comprises the searching unit 303 and the query request combining unit 304, it is obvious for those skilled in the art that the traffic information processing device 30 may only comprises the searching unit 303.

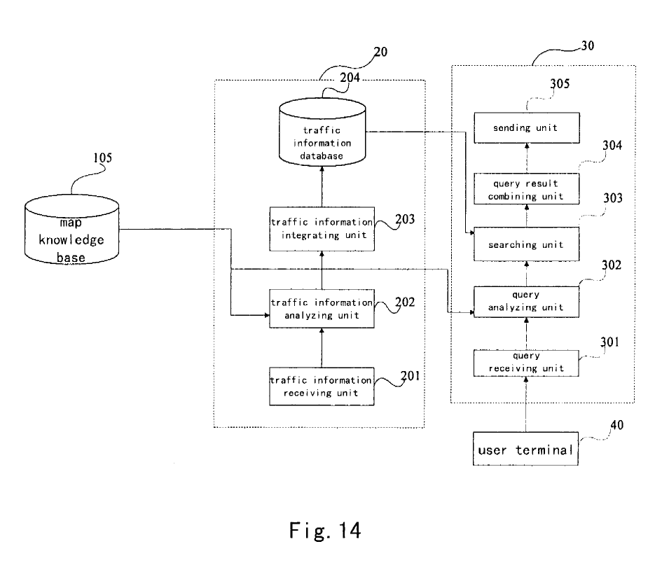

FIG. 14 shows a schematic block of the traffic information gathering and searching system according to another example of the invention. The traffic information gathering and searching system comprises a traffic information processing device 20 for processing the traffic information received from a user, a query information processing device 30 for processing the query request received from a user, a memory unit for storing the traffic status description table of the traffic status and a communication network (not shown). The map knowledge base 10 is a known knowledge base for storing the knowledge related to the attributes of roads and traffic points, attribute values corresponding to the related attributes and the spatial information among the attribute values. The traffic point usually includes road node and roadside point.

The map knowledge base 105 may be internal to the traffic information gathering and searching system or be external to the traffic information gathering and searching system so as to be accessed by the traffic information processing device 20 and the query information processing device 30. Since the structure of the traffic information processing device 20 and the query information processing device 30 are identical with that of FIG. 10, here the description of them will be omitted.

By using the traffic information gathering and searching system of the present invention, much more traffic information can be gathered from the user terminal and the user terminal implements an effect of query request for the traffic information conveniently and in-time. Since the traffic query request system decomposes the query request of the user into the minimum query request according to the knowledge of the map knowledge base, the invention have the effective advantage of performing accurate query on the basis of understanding the intention of the user's query request.

While specific embodiment and applications of the present invention have been illustrated and described, it should be understood that the invention is not limited to the precise configuration and components disclosed herein. Various modifications, changes, and variations which will be apparent to those skilled in the art may be made in the arrangement, operation, and details of the methods and system of the present invention disclosed herein without departing from the spirit and scope of the invention.

What is claimed is:

1. A traffic information gathering device, comprising:
a map knowledge base generating section for generating information comprising attributes of roads and traffic points, attribute values corresponding to the attributes, and spatial relationship among the attribute values based on an electronic map so as to form a map knowledge base; and
a traffic information processing section for receiving traffic information from a user terminal, and decomposing the traffic information if it is determined that the traffic information can be decomposed according to the map knowledge base, so as to generate traffic information corresponding to attribute values of roads or traffic points.

2. The traffic information gathering device according to claim 1, wherein the map knowledge base generating section comprises:
an attribute value extracting unit for extracting attribute values corresponding to attributes of the roads and traffic points from the electronic map;
an attribute value spatial relationship forming unit for forming spatial correspondence relationship among attribute values of the roads and traffic points; and
a combining unit for combining the attributes of roads and traffic points and the corresponding attribute values, spatial correspondence relationship among attribute values and spatial correspondence relationship based axiom so as to form the map knowledge base.

3. The traffic information gathering device according to claim 1, wherein the traffic information processing section comprises:
a traffic information receiving unit for receiving the traffic information from the user terminal as first traffic information;
a traffic information analyzing unit for identifying the format of the first traffic information, decomposing the first traffic information into a second traffic information which is corresponding to the attribute values of roads or traffic points if it is determined that the first traffic information can be decomposed according to the map knowledge base;
a traffic information integrating unit for integrating the first and second traffic information with the traffic information of a traffic information database and updating the traffic information database using the integrated traffic information.

4. The traffic information gathering device according to claim 3, wherein the traffic information analyzing unit identifies the format of the first traffic information by the steps of:
determining whether the first traffic information corresponds to one of the formats “where, traffic status”, “where, direction, traffic status”, “where, traffic status, time, time” and “where, direction, traffic status, time” or not; and
if not, then converting the first traffic information into a format which corresponds to one of the formats.

5. A traffic information gathering method, comprising:
a map knowledge base generating step for generating information comprising attributes of roads and traffic points, attribute values corresponding to the attributes, and spatial relationship among the attribute values based on an electronic map so as to form a map knowledge base; and
a traffic information processing step for receiving traffic information from a user terminal, and decomposing the traffic information if it is determined that the traffic information can be decomposed by using the map knowledge base, so as to generate traffic information corresponding to attribute values of roads or traffic points.

6. The traffic information gathering method according to claim 5, wherein the map knowledge base generating step comprises:
an attribute value extracting step for extracting attribute values corresponding to attributes of the roads and traffic points from the electronic map;
an attribute value spatial relationship forming step for forming spatial correspondence relationship among attribute values of the roads and traffic points; and
a combining step for combining the attributes of roads and traffic points and the corresponding attribute values, spatial correspondence relationship among attribute values and the spatial correspondence relationship based axiom so as to form the map knowledge base.

7. The traffic information gathering method according to claim 5, wherein traffic information processing step comprises:
a traffic information receiving step for receiving the traffic information from the user terminal as first traffic information;
a traffic information analyzing step for identifying the format of the first traffic information, decomposing the first traffic information into second traffic information which is corresponding to the attribute values of roads or traffic points if it is determined that the first traffic information can be decomposed according to the map knowledge base; and
a traffic information integrating step for integrating the first and second traffic information with the traffic information of a traffic information database and updating the traffic information database using the integrated traffic information.

8. The traffic information gathering method according to claim 7, wherein the traffic information analyzing step identifies the format of the first traffic information by the steps of:
determining whether the first traffic information corresponds to one of the formats “where, traffic status”, “where, direction, traffic status”, “where, traffic status, time, time” and “where, direction, traffic status, time” or not; and
if not, then translating the first traffic information into a format which corresponds to one of the formats.

9. A traffic information gathering device, comprising:
a traffic information receiving section for receiving the traffic information from the user terminal as first traffic information;
a traffic information analyzing section for identifying the format of the first traffic information, decomposing the first traffic information into second traffic information which is corresponding to the attribute values of roads or traffic points if is determined that the first traffic information can be decomposed according to the map knowledge base, wherein the map knowledge base comprises knowledge related to attributes of roads and traffic points, attribute values
corresponding to the attributes, and spatial relationship among the attribute values based on an electronic map; and
a traffic information integrating section for integrating the first and second traffic information with the traffic information of a traffic information database and updating the traffic information database using the integrated traffic information.

10. The traffic information gathering device according to claim 9, further comprising a map knowledge base.

11. The traffic information gathering device according to claim 10, wherein the traffic information analyzing section identifies the format of the first traffic information by the steps of:
determining whether the first traffic information corresponds to one of the formats “where, traffic status”, “where, direction, traffic status”, “where, traffic status, time” and “where, direction, traffic status, time” or not; and
if not, then translating the first traffic information into a format which corresponds to one of the formats.

12. A traffic information gathering method, comprising:
a receiving step for receiving the traffic information from the user terminal as first traffic information;
an traffic information analyzing step for identifying the format of the first traffic information, decomposing the first traffic information into second traffic information which is corresponding to the attribute values of roads or traffic points when the first traffic information can be decomposed according to the map knowledge base, wherein the map knowledge base comprising information related to attributes of roads and traffic points, attribute values corresponding to the attributes, and spatial relationship among the attribute values based on an electronic map; and
an traffic information integrating step for integrating the first and second traffic information with the traffic information of a traffic information database and updating the traffic information database using the integrated traffic information.

13. The traffic information gathering method according to claim 12, wherein the traffic information analyzing step identifies the format of the first traffic information by the steps of:
determining whether the first traffic information corresponds to one of the formats “where, traffic status”, “where, direction, traffic status”, “where, traffic status, time” and “where, direction, traffic status, time” or not; and
if not, then translating the first traffic information into a format which corresponds to one of the formats.

14. A traffic information gathering and searching system for receiving traffic information from a user terminal and providing traffic information query service, comprising:
a map knowledge base generating section for generating information comprising attributes of roads and traffic points, attribute values corresponding to the attributes, and spatial relationship among the attribute values based on an electronic map so as to form a map knowledge base;
a traffic information processing section for receiving traffic information from the user terminal, and decomposing the traffic information if it is determined that the traffic information can be decomposed according to the map knowledge base, so as to generate traffic information corresponding to attribute values of roads or traffic points; and
a query information processing section for receiving a query request from the user terminal and analyzing it, decomposing the query request if it is determined that the query request can be composed according to the map knowledge base, and searching the traffic information database based on the decomposed query request.

15. The traffic information gathering and searching system according to claim 14, wherein the map knowledge base generating section comprises:
an attribute value extracting unit for extracting attribute values corresponding to attributes of the roads and traffic points from the electronic map;
attribute value spatial relationship forming unit for forming spatial corresponding relationship among attribute values of the roads and traffic points; and
a combining unit for combining the attributes of roads and traffic points and the corresponding attribute values thereof, spatial correspondence relationship among attribute values of roads and traffic points and spatial correspondence relationship based axiom so as to form the map knowledge base.

16. The traffic information gathering and searching system according to claim 14, wherein the traffic information processing section comprises:
a traffic information receiving unit for receiving the traffic information from the user terminal as first traffic information;
a traffic information analyzing unit for identifying the format of the traffic information, decomposing the first traffic information into second traffic information which is corresponding to the attribute values of roads or traffic points when the traffic information can be decomposed according to the map knowledge base; and
a traffic information integrating unit for integrating the first and second traffic information with the traffic information of a traffic information database and updating the traffic information database using the integrated traffic information.

17. The traffic information gathering and searching system according to claim 18, wherein the first analyzing unit identifies the format of the first traffic information by the steps of:
determining whether the first traffic information corresponds to one of the formats “where, traffic status”, “where, direction, traffic status”, “where, traffic status, time” and “where, direction, traffic status, time” or not; and
if not, then translating the first traffic information into a format which corresponds to one of the formats.

18. The traffic information gathering and searching system according to claim 14, wherein the query information processing section comprises:
a query request receiving unit for receiving the query request from the user terminal as a first query;
a query request analyzing unit for identifying the format of the first query request, decomposing the first query request into second query request which is corresponding to the attribute values of roads or traffic points if it is determined that the first query request can be decomposed according to the map knowledge base;
a searching unit for searching the traffic information from the traffic information database based on the first or the second query request and summarizing the initial searched result to a query result corresponding to the query request; and
a sending unit for sending the searched result to the user terminal.

19. The traffic information gathering and searching system according to claim 18, wherein the query information processing section further comprises:
a traffic result combining unit, for combining the similar traffic information from the initial searched result so as to form the query result.

20. The traffic information gathering and searching system according to claim 19, wherein the searched result comprises a traffic information summary part and a detail description part.

21. The traffic information gathering and searching system according to claim 18, wherein the second analyzing unit identifies the format of the first query request to the steps of:
determining whether the first query request is corresponding to one of the formats “where”, “where, direction”, “where, question”, “where, time”, “where, direction, question”, “where, time, question”, “where, direction, time” and “where, direction, question, time” or not; and
if not, then translating the query request into a format which is corresponding to one of the formats.

22. The traffic information gathering and searching system according to claim 18, wherein the sending unit sends the searched result in at least one of the text format, image format and voice format.

23. The traffic information gathering and searching system according to claim 13, wherein the user terminal comprises a wireless communication terminal or a wired communication terminal.

24. A traffic information gathering and searching method for receiving traffic information from a user terminal and providing traffic information query request service, comprising:
a map knowledge base generating step for generating information comprising attributes of roads and traffic points, attribute values corresponding to the attributes, and spatial relationship of the attribute values based on an electronic map so as to form a map knowledge base;
a traffic information processing step for receiving traffic information from the user terminal and analyzing it, and decomposing the traffic information if it is determined that the traffic information can be decomposed according to the map knowledge base, so as to generate traffic information corresponding to attribute values of roads or traffic points; and
a user terminal, decomposing the query request if it is determined that the query request can be composed according to the map knowledge base, and searching the traffic information database based on the decomposed query request.

25. The traffic information gathering and searching method according to claim 24, wherein the map knowledge base generating step comprises:
an attribute value extracting unit for extracting attribute values corresponding to attributes of the roads and traffic points from the electronic map;
attribute value spatial relationship forming unit for forming spatial corresponding relationship among attribute values of attributes of the roads and traffic points; and
a combining step for combining the attributes of roads and traffic points and the corresponding attribute values thereof, spatial correspondence relationship among attribute values of roads and traffic points and spatial correspondence relationship based axiom so as to form the map knowledge base.

26. The traffic information gathering and searching method according to claim 24, wherein the first traffic information processing step comprises:
a traffic information receiving step for receiving the traffic information from the user terminal as first traffic information;
a traffic information analyzing step for identifying the format of the traffic information, decomposing the first traffic information into second traffic information which is corresponding to the attribute values of roads or traffic points when the first traffic information can be decomposed according to the map knowledge base; and
a traffic information integrating step for integrating the first and second traffic information with the traffic information in a traffic information database and updating the traffic information database using the integrated traffic information.

27. The traffic information gathering and searching method according to claim 26, wherein the first traffic information analyzing step identifies the format of the first traffic information by the steps of:
determining whether the traffic information corresponds to one of the formats “where, traffic status”, “where, direction, traffic status”, “where, traffic status, time” and “where, direction, traffic status, time” or not; and
if not, then translating the first traffic information into a format which corresponds to one of the formats.

28. The traffic information gathering and searching method according to claim 24, wherein the query information processing step comprises:
a query request receiving step for receiving the query request from the user terminal as a first query request;
a query analyzing step for identifying the format of the first query request, decomposing the first query request into second query request which is corresponding to the attribute values of roads or traffic points when the first query request can be decomposed according to the map knowledge base;
a searching step for searching the traffic information from the traffic information database based on the first query request or the second query request and summarizing the initial searched result to query result corresponding to the query request; and
a sending step for sending the searched result to the second user terminal.

29. The traffic information gathering and searching method according to claim 28, wherein the query information processing step further comprises:
a query result combining step, for combining the similar traffic information from the initial searched result so as to form the searched result.

30. The traffic information gathering and searching method according to claim 29, wherein the result comprises a traffic information summary part and a detail description part.

31. The traffic information gathering and searching method according to claim 28, wherein the query analyzing step identifies the format of the first query request by the steps of:
determining whether the first query request corresponds to one of the formats “where”, “where, direction”, “where, question”, “where, time”, “where, direction, question”, “where, time question”, “where, direction, time” and “where, direction, question, time” or not; and
if not, then translating the first query request into a format which corresponds to one of the formats.

32. The traffic information gathering and searching method according to claim 28, wherein the sending step sends the searched result in at least one of the text format, image format and voice format.

33. The traffic information gathering and searching method according to claim 23, wherein user terminal is a wireless communication terminal or a wired communication terminal.

34. A traffic information gathering and searching system for receiving traffic information from a user terminal and providing traffic information query service, comprising:
a traffic information processing section for receiving traffic information from the user terminal, and decomposing the traffic information if it is determined that the traffic information can be decomposed according to the map knowledge base, so as to generate traffic information corresponding to attribute values of roads or traffic points, wherein the map knowledge base comprises knowledge related to attributes of roads and traffic points, attribute values corresponding to the attributes, and spatial relationship of the attribute values based on an electronic map; and
a query information processing section for receiving a query request from the user terminal, decomposing the query request if it is determined that the query request can be composed according to the map knowledge base, and searching the traffic information database based on the decomposed query request.

35. The traffic information gathering and searching system according to claim 34, wherein the system further comprises:
a map knowledge base.

36. The traffic information gathering and searching system according to claim 34, wherein the traffic information processing section comprises:
a traffic information receiving unit for receiving the traffic information from the user terminal as first traffic information;
a traffic information analyzing unit for identifying the format of the first traffic information, decomposing the first traffic information into second traffic information which is corresponding to the attribute values of roads or traffic points when the first traffic information can be decomposed according to the map knowledge base; and
a traffic information integrating unit for integrating the first and second traffic information with the traffic information of a traffic information database and updating the traffic information database using the integrated traffic information.

37. The traffic information gathering and searching system according to claim 36, wherein the first analyzing unit identifies the format of the first traffic information by the steps of:
determining whether the first traffic information corresponds to one of the formats “where, traffic status”, “where, direction, traffic status”, “where, traffic status, time” and “where, direction, traffic status, time” or not; and
if not, then translating the traffic information into a format which corresponds to one of the formats.

38. The traffic information gathering and searching system according to claim 34, wherein the query information processing section comprises:
a query receiving unit for receiving the query request from the user terminal as a first query request;
a query analyzing unit for identifying the format of the query request, decomposing the first query request into second query request which is corresponding to the attribute values of roads or traffic points when the first query request can be decomposed according to the map knowledge base;
a searching unit for searching the traffic information from the traffic information database based on the first or the second query request and summarizing the initial searched result to query result corresponding to the query request; and
a sending unit for sending the searched result to the user terminal.

39. The traffic information gathering and searching system according to claim 38, wherein the second traffic information processing section further comprises:
a query result combining unit, for combining the similar traffic information from the initial searched result so as to form the searched result.

40. The traffic information gathering and searching system according to claim 39, wherein the searched result comprises a traffic information summary part and a detail description part.

41. The traffic information gathering and searching system according to claim 38, wherein the query analyzing unit identifies the format of the first query request by the steps of:
determining whether the query request corresponds to one of the formats “where”, “where, direction”, “where, question”, “where, time”, “where, direction, question”, “where, time, question”, “where, direction, time” and “where, direction, question, time” or not, and if not, then translating the first query request into a format which corresponds to one of the formats.

42. The traffic information gathering and searching system according to claim 38, wherein the sending unit sends the searched result in at least one of the text format, image format and voice format.

43. The traffic information gathering and searching system according to claim 34, wherein the user terminal is a wireless communication or a wired communication terminal.

44. A traffic information gathering and searching method for receiving traffic information from a user terminal and analyzing it, providing traffic information query request service, comprising:
a traffic information processing step for receiving traffic information from the user terminal and analyzing it, and decomposing the traffic information if it is determined that the traffic information can be decomposed according to the map knowledge base, so as to generate traffic information corresponding to attribute values of roads or traffic points, wherein the map knowledge base comprises knowledge related to attributes of roads and traffic points, attribute values corresponding to the attributes, and spatial relationship among the attribute values based on an electronic map; and
a query information processing step for receiving a query request from the user terminal and analyzing it, decomposing the query request if it is determined that the query request can be composed according to the map knowledge base, and searching the traffic information database based on the decomposed query request.

45. The traffic information gathering and searching method according to claim 44, wherein the traffic information processing step comprises:
a traffic information receiving step for receiving the traffic information from the user terminal as first traffic information;
a traffic information analyzing step for identifying the format of the traffic information, decomposing the first traffic information into second traffic information which corresponds to the attribute values of roads or traffic points when the first traffic information can be decomposed according to the map knowledge base; and
a traffic information integrating step for integrating the first or second traffic information with the traffic information in a traffic information database and updating the traffic information database using the integrated traffic information.

46. The traffic information gathering and searching method according to claim 45, wherein the first traffic information analyzing step identifies the format of the first traffic information by the steps of:
determining whether the first traffic information corresponds to one of the formats “where, traffic status”, “where, direction, traffic status”, “where, traffic status, time” and “where, direction, traffic status, time” or not; and
if not, then translating the first traffic information into a format which corresponds to one of the formats.

47. The traffic information gathering and searching method according to claim 44, wherein the query information processing step comprises:
a query receiving step for receiving the query request from the user terminal as first traffic information;
a query analyzing step for identifying the format of the first query request, decomposing the first query request into second query request which corresponds to the attribute values of roads or traffic points when the first query request can be decomposed according to the map knowledge base;
a searching step for searching the traffic information from the traffic information database based on the first or the second query request and summarizing the initial searched result to query result corresponding to the query request; and
a sending step for sending the searched result to the second user terminal.

48. The traffic information gathering and searching method according to claim 47, wherein the query information processing step further comprises:
a query result combining step, for combining the similar traffic information from the initial searched result so as to form the searched result.

49. The traffic information gathering and searching method according to claim 48, wherein the result comprises a traffic information summary part and a detail description part.

50. The traffic information gathering and searching method according to claim 47, wherein the query analyzing step identifies the first query request by the steps of:
determining whether the first query request is corresponding to one of the formats “where”, “where, direction”, “where, question”, “where, time”, “where, direction, question”, “where, time, question”, “where, direction, time” and “where, direction, question, time” or not; and
if not, then translating the first query request into a format which is corresponds to one of the formats.

51. The traffic information gathering and searching method according to claim 47, wherein the sending step sends the searched result in at least one of the text format, image format and voice format.

52. The traffic information gathering and searching method according to claim 44, wherein the user is a wireless communication terminal or a wired communication terminal.
